(19) United States
(12) Patent Application Publication
(10) Pub. No.: US 2011/0055701 A1
(43) Pub. Date: Mar. 3, 2011

(54) ELECTRONIC DEVICE AND METHOD FOR PLAYING INTERNET RADIO

(75) Inventors: CHIA-PENG WANG, Tu-Cheng (TW); TIEN-PING LIU, Tu-Cheng (TW)

(73) Assignee: HON HAI PRECISION INDUSTRY CO., LTD., Tu-Cheng (TW)

(21) Appl. No.: 12/610,387

(22) Filed: Nov. 2, 2009

(30) Foreign Application Priority Data
Aug. 27, 2009 (CN) 200910306180.5

(51) Int. Cl. G06F 3/00; H04B 1/18

(52) U.S. Cl. 715/716; 455/154.1

(57) ABSTRACT

An electronic device is capable of communicating with internet radio stations via a network, and includes a configuration module, an API module, a downloading module, and a GUI module. The configuration module is capable of setting search conditions for searching the internet radio stations in the network. The API module is capable of sending a download command according to the search condition to the download module of the electronic device if the search conditions are selected. The download module is capable of downloading a list of the internet radio stations, and downloading contents of one internet radio station if the one internet radio station is selected in the list. The GUI module is capable of displaying the list and playing the contents.

### BACKGROUND

1. Technical Field

The present disclosure relates to electronic devices and methods, and particularly to an electronic device and a method for playing internet radio.

2. Description of Related Art

Now, many radio stations broadcast on the internet. In order to listen to desired radio station, a user may have to search for the radio station by keying in different terms to a network search engine, such as Google, Baidu, and so on, this is very time-consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device communicating with an internet radio station via a network, in accordance with an embodiment.

FIG. 2 is a block diagram of the electronic device of the embodiment of FIG. 1.

FIG. 3 is a flow chart of a method for the electronic device of FIG. 2 for playing contents of internet radio stations.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

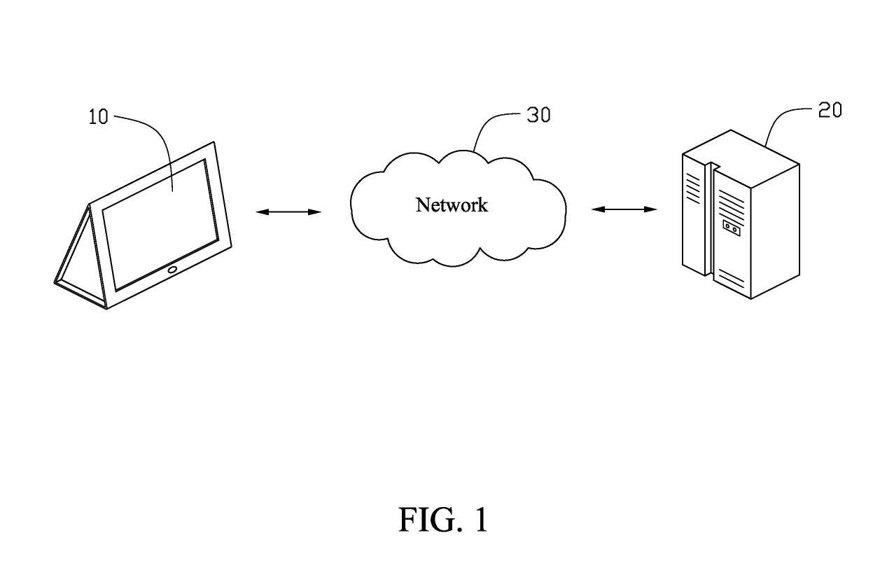

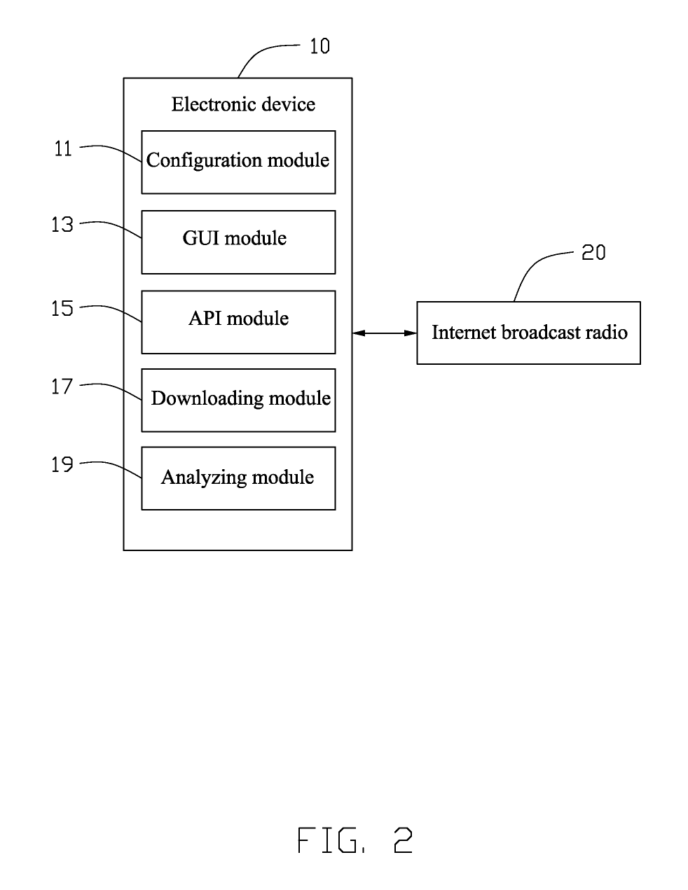

FIG. 1 illustrates an electronic device 10, in accordance with an embodiment, communicating with a plurality of internet radio stations 20 (only one shown in FIGS. 1-2) via a network 30. In one embodiment, the electronic device 10 may be a digital photo frame, for example. The internet radio station 20 can broadcast one or more radio channels via the network 30. The network 30 may be the Internet, for example.

FIG. 2 illustrates the electronic device 10 communicating with the internet radio station 20. The electronic device 10 includes a configuration module 11, a graphical user interface (GUI) module 13, an application programming interface (API) module 15, a downloading module 17, and an analyzing module 19.

The configuration module 11 is capable of setting search conditions for searching internet radio stations 20 on the network 30. In one embodiment, the search conditions include locations and types. The locations may be, for example, United States, China, Japan, or other countries. The types may be, for example, economy, literature, etc.

The GUI module 13 is capable of displaying the search conditions. The GUI module 13 can be used to select the locations and the types.

The API module 15 is capable of sending search commands containing the search conditions to the downloading module 17.

The searching module 17 is capable of searching the network for the internet radio stations 20 according to the search conditions, and creating a list of available stations to the electronic device 10 after receiving the download commands. The list of stations includes, but not limited to, names of the internet radio hosts 20. In one embodiment, the contents may be audio contents, video contents, etc., for example.

The GUI module 13 is further capable of displaying the list downloaded by the downloading module 17.

The analyzing module 19 is capable of determining sort conditions, and sorting the list according to the sort conditions. The sort conditions are displayed in the GUI module 13. In one embodiment, the sort conditions may be by popularity and name, for example. In the GUI module 13, the popularity and the name can be selected to filter the list of the internet radio stations 20.

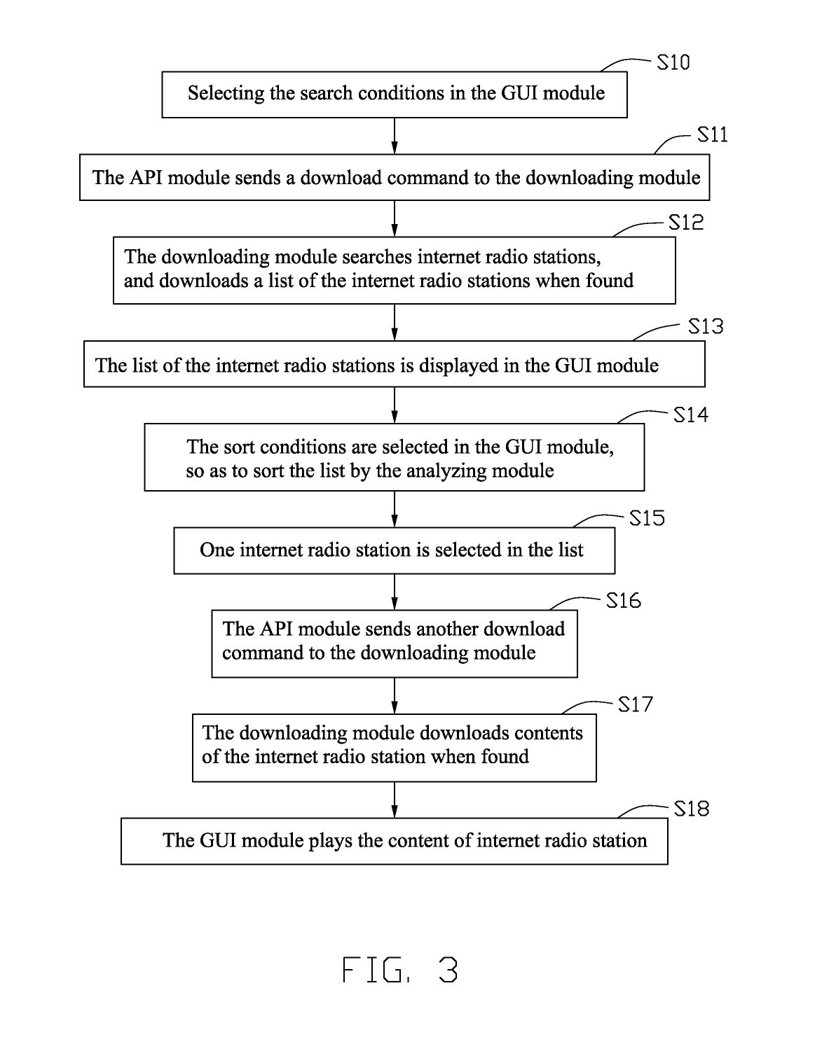

FIG. 3 illustrates a flow chart of a method for playing contents of a internet radio station, in accordance with one embodiment.

In block S10, the search conditions are selected through the GUI module 13. For example, the country “China” and the genre “economy” are both selected.

In block S11, the API module 15 sends a download command with the selected search conditions to the downloading module 17.

In block S12, the downloading module 17 searches internet radio stations 20 in the network 30 according to the sort conditions, and downloads a list of the internet radio stations 20 when found to the electronic device 10.

In block S13, the list of the internet radio stations 20 is displayed in the GUI module 13.

In block S14, the sort conditions are selected in the GUI module 13, so as to sort the list by the analyzing module 19. For example, either the sort condition “popularity” or “name” is selected, the list will be reordered under the sort condition “popularity” or “name”.

In block S15, one internet radio station 20 is selected in the list.

In block S16, the API module 15 sends a download command with the one internet radio station 20 to the downloading module 17.

In block S15, the downloading module 17 downloads contents of the internet radio stations 20 when found.

In block S17, the GUI module 13 plays the content of the internet radio stations 20.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An electronic device capable of communicating with internet radio stations via a network, the electronic device comprising:
a configuration module capable of setting search conditions for searching the internet radio stations in the network;
an application programming interface module capable of sending a download command according to the search condition to a download module of the electronic device if the search conditions are selected;
the download module capable of downloading a list of the internet radio stations, and downloading contents of one internet radio station if the one internet radio station is selected in the list; and
a graphical user interface (GUI) module capable of displaying the list and playing the contents.

2. The electronic device of claim 1, wherein the search conditions includes locations and types.

3. The electronic device of claim 1, wherein the search conditions are displayed in the GUI module.

4. The electronic device of claim 1, further comprising an analyzing module capable of determining sort conditions, and reordering of the list of the internet radio stations according to the sort conditions.

5. The electronic device of claim 4, wherein the sort conditions comprises popularity and name.

6. The electronic device of claim 4, wherein the sort conditions are displayed in the GUI module.

7. A method for an electronic device playing contents of internet radio stations via a network, the method comprising:
selecting search conditions in a graphical user interface (GUI) module;
sending a download command according to the search condition by an application programming interface module to a download module of the electronic device;
downloading a list of the internet radio stations to the electronic device;
displaying the list in the electronic device by the GUI module;
selecting one internet radio station in the list; and
playing the contents by the GUI module.

8. The method of claim 7, wherein a configuration of the electronic device is capable of setting the search conditions.

9. The method of claim 7, wherein the search conditions includes locations and types.

10. The method of claim 9, wherein the search conditions is displayed in the GUI module.

11. The method of claim 7, wherein an analyzing module of the electronic device is capable of determining sort conditions.

12. The method of claim 11, further comprising reordering of the list of the internet radio stations according to the sort conditions by the analyzing module before selecting the one internet radio station.

13. The method of claim 11, wherein the sort conditions comprises popularity and name.

14. The method of claim 11, wherein the sort conditions are displayed in the GUI module.
